(19) United States
(12) Patent Application Publication
(10) Pub. No.: US 2026/0208757 A1
(43) Pub. Date: Jul. 23, 2026

(54) VEHICLE, DRIVING ASSISTANCE SYSTEM, AND METHOD FOR SEPARATE HANDLING OF OBSTACLES IN TRAINED TRAJECTORIES

(71) Applicant: Volkswagen Aktiengesellschaft, Wolfsburg (DE)

(72) Inventors: Niklas Koch, Wolfsburg (DE); Jana Seeland, Wolfsburg (DE); Christian Hopp, Wolfsburg (DE)

(21) Appl. No.: 19/453,133

(22) Filed: Jan. 20, 2026

(30) Foreign Application Priority Data
Jan. 17, 2025 (DE) 10 2025 101 557.0

(51) Int. Cl. B60W 50/14; B60W 30/09; B60W 50/08

(52) U.S. Cl. CPC B60W 50/14; B60W 30/09; B60W 50/085; B60W 2554/20; B60W 2720/10; B60W 2754/10

(57) ABSTRACT

A method for operating a driving assistance system of a vehicle to enable optimized handling of obstacles along a trajectory. The vehicle is guided by the driving assistance system along a trajectory that was taught by the driving assistance system. When an unknown obstacle is sensed along the trajectory and the obstacle has not been recognized at the time of teaching the trajectory, the system outputs a query to a driver of the vehicle that is related to performing an action for handling the unknown obstacle by the driving assistance system, and/or the driver is prompted to edit the trajectory in a communication device.

### CROSS-REFERENCE TO RELATED APPLICATION

This application claims the priority, under 35 U.S.C. § 119, of German Patent Application DE 102025101 557.0, filed January 17, 2025; the prior application is herewith incorporated by reference in its entirety.

### FIELD AND BACKGROUND OF THE INVENTION

The invention relates to a method for operating a driving assistance system of a vehicle, to a driving assistance system configured for performing such a method, and to a vehicle having such a driving assistance system.

With a trajectory trained by a driving assistance system of a vehicle, some obstacles may occur on the trajectory which should be met with special handling, such as, e.g., shrubbery or curbs.

After training the trajectory, obstacles, e.g., such as shrubbery, may change shape and protrude into the trajectory. Environmental sensorics of the vehicle would recognize the shrub as an obstacle and the trajectory could thus possibly no longer be driven on even though the driver would be able to travel on the trajectory in case of manual driving. On the other hand, it may be sensible to label certain recognized obstacles as being able to be driven over, e.g., in situations such as weeds in a paved driveway.

Methods for differentiating obstacles that are able to be driven on and are unable to be driven on along a trajectory are known, for example, from German published patent applications DE 102015205142 A1, from DE 102019130894 A1, and from DE 102014014219 A1.

### SUMMARY OF THE INVENTION

It is an object of the invention to provide a method for operating a driving assistance system enabling optimized handling of obstacles along a trajectory.

With the above and other objects in view there is provided, in accordance with the invention, a method of operating a driving assistance system of a vehicle, the method comprising the following steps:

guiding the vehicle along a trajectory taught by the driving assistance system;

sensing at least one unknown obstacle along the trajectory, wherein the obstacle was not recognized at a time of teaching the trajectory; and

performing at least one of:

outputting a query to a driver of the vehicle related to performing an action for handling the unknown obstacle by the driving assistance system; or

editing the trajectory in a communication device by the driver.

The method advantageously enables optimizing how obstacles are handled along a taught trajectory since, based on input by the driver or the user, an action adjusted with regard to the type of the obstacle may be performed by the driving assistance system. This advantageously leads to fewer system aborts or trip aborts by the driving assistance system. They would otherwise occur if, during a repeat trip along a trajectory taught beforehand, a change occurs in an obstacle (e.g., curb, leaves, grass, ...) previously categorized by the driving assistance system as being able to be driven on, under, over, or through, and now, during the repeat trip, the driving assistance system categorizes it as being unable to be driven on, under, over, or through, and possibly aborts the trip.

Output of the query to the driver may be via a display in the vehicle, for example, via the instrument panel or a head-up display. The query may prompt the driver to make a decision as to how the driving assistance system should deal with the unknown obstacle.

Having the obstacle assessed by the driver or a user of the vehicle makes the method particularly reliable. In particular in safety-relevant situations in which, for example, a child is located in or near a shrub, this may allow reliable evaluation of how to deal with the obstacle. This is because, while it might be possible to drive closely past a shrub, this is not desired if a child is additionally located in its proximity.

During teaching, also referred to as a teach-in, the trajectory is recorded for the first time, and corresponding data for the trajectory is generated which in particular also comprises data related to recognized obstacles along the trajectory. Over the course of the method, this data may correspondingly be changed and/or supplemented during a repeat trip along the trajectory.

A previously unrecognized obstacle may be understood to mean an obstacle which was previously not present along the trajectory in the sensing region of the sensorics or a previously pre-existing obstacle which, however, has changed its shape and/or position and thus is categorized by the sensorics as unknown.

The driving assistance system may either query the driver if the driving assistance system detects a new or changed obstacle by means of sensorics during repeat travel on the trajectory. The driver may then decide which action or actions should be initiated with regard to the obstacle. Further, the driver may proactively edit the trajectory if the driver establishes, for example, that growth formed in a front yard driveway impairs, or could in the future impair, the driving assistance system.

In particular, the method is employed during automated or at least partially automated driving along the trajectory.

Preferably, the method is used during an assisted or automated parking procedure. Further, it is possible for a spatial region which has been changed over the course of the method to be provided in the form of a digital map in other driving functions as well.

If the obstacle is no longer recognized during any later trips along the trajectory, then the obstacle may be deleted from the trajectory data. Repeat occurrence of the obstacle must then be confirmed again.

Preferably, the obstacle is vegetation, a living being, a ground region, a curb, a building, or an infrastructure device, such as, for example, road signs, traffic signals, or street lamps. Obstacles may either appear or change during further driving, for example, shrubbery, grass, foliage, or weeds on a paved ground growing into the trajectory, or may be static, e.g., a curb, a wall, a curve section, or a flower bed. The variety of the obstacles sensed enables comprehensive and reliable guidance of the vehicle along the trajectory.

Preferably, sensing the obstacle is done by the driver or by sensorics of the driving assistance system. For example, the driver may proactively change the trajectory if they themselves have recognized the obstacle, or the driver may only react upon being prompted by the driving assistance system which senses the obstacle. To recognize the obstacle, the sensorics then assess image data, in particular, for example by means of semantic segmentation, compare image data from teaching to image data from the current trip, and sense potential differences.

Preferably, the action comprises aborting guiding the vehicle along the trajectory. This may be the case if, for example, the obstacle is unable to be driven on, under, over, or through, even if only temporarily, for example. For example, the obstacle may be a living being. Aborting may in particular be aborting guiding the vehicle by the assistance system.

Preferably, the action comprises driving around the obstacle. If, for example, the driver establishes that the obstacle is unable to be driven on, under, over, or through, for example, since it is a flower bed or strong vegetation, but there is sufficient space to drive around it, this action may be taken. In particular, driving around it is understood to mean guiding the vehicle around the obstacle.

Preferably, the driver monitors driving around the obstacle, or the vehicle is guided by the driver while driving around the obstacle. The driver may be located in the vehicle or in proximity to the vehicle while monitoring. Further, the driver may conduct the monitoring via a communication device of the vehicle with a display device, for example, a human-machine interface (HMI). Additionally, it is possible for the driver to specify a region for driving around the obstacle via such a communication device.

Preferably, the action comprises disregarding, in particular once or permanently, the obstacle. Preferably, for safety reasons, the driver must confirm, in particular by input to the communication device, that the trajectory contains disregarded obstacles.

Preferably, the action comprises increasing or decreasing a safe distance from the obstacle. This may be advantageous, for example, if the vehicle approaches a curb, for protecting the wheel rims.

Preferably, the action comprises increasing or decreasing a speed of the vehicle while driving along the obstacle. This may be advantageous, for example, if the vehicle is to slowly drive onto a curb. Further, safety may be increased by means of an adjusted way of driving.

Preferably, the obstacle is stored in the data of the trajectory. This is in particular done when recognizing an obstacle for the first time or if pre-existing data for an obstacle needs to be updated when a particular action has been established or the obstacle has been re-categorized by the driver.

Preferably, the obstacle is classified by the driver or by the driving assistance system as an obstacle that is able to be driven over, in particular able to be driven on, under, over, or through, or is unable to be driven over, in particular unable to be driven on, under, over, or through. The information on the classification may be stored in the driving assistance system. In particular, the classification may improve any future recognition of the obstacle by the sensorics of the driving assistance system. For example, it may be classified whether the obstacle is vegetation, a living being, a ground region, a curb, a building, or an infrastructure device.

To increase safety when performing the method, the driving assistance system may compare image data from teaching to image data from the current trip and sense any differences. In relation to a difference between the image data, a threshold may be established above which an obstacle previously classified as being able to be driven over, for example a shrub, is now no longer categorized as being able to be driven over, for example, a shrub with a human being in its proximity or a human being located in the shrub. A further example may be a curb which on its own is categorized as being able to be driven over, however, this is no longer the case if an animal is present in its proximity. Additionally, confirmation by the driver may be sought if classification by the driving assistance system is unclear or impossible, in particular, if a living being is presumed.

Preferably, editing the trajectory by the driver comprises adjusting at least one region along the trajectory. For example, the driver may establish that a region along the trajectory is categorized as being able to be driven over or unable to be driven over. In particular, multiple potential obstacles may be located in such a region. Editing may be via the communication device, in particular the HMI, of the vehicle and/or via an online interface, e.g., in a browser or a mobile handset.

Editing the trajectory may in particular comprise classifying. Thus, the driver may already classify potential obstacles before they are recognized by the driving assistance system as possibly unknown so that the query to the driver may advantageously be omitted.

With the above and other objects in view there is also provided, in accordance with the invention, a driving assistance system configured for performing a method according to any one of the preceding embodiments. The driving assistance system comprises at least the sensorics and a control device which assesses measurement data of the sensorics and outputs corresponding control commands for interaction with the driver and controlling the vehicle.

Further, the object of the invention is also attained by a vehicle having the driving assistance system described above.

Other features which are considered as characteristic for the invention are set forth in the appended claims.

Although the invention is illustrated and described herein as embodied in a vehicle, driving assistance system, and method for separate handling of obstacles in trained trajectories, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a flow chart illustrating a method for operating a driving assistance system of a vehicle for handling unknown objects along a taught trajectory; and

FIG. 2 shows a vehicle having a control device configured for performing the method.

### DETAILED DESCRIPTION OF THE INVENTION

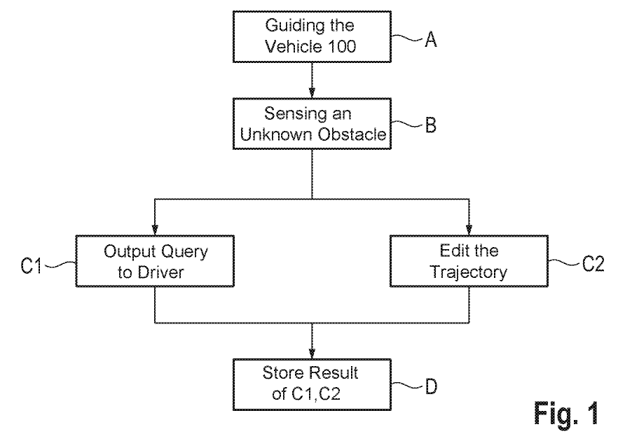

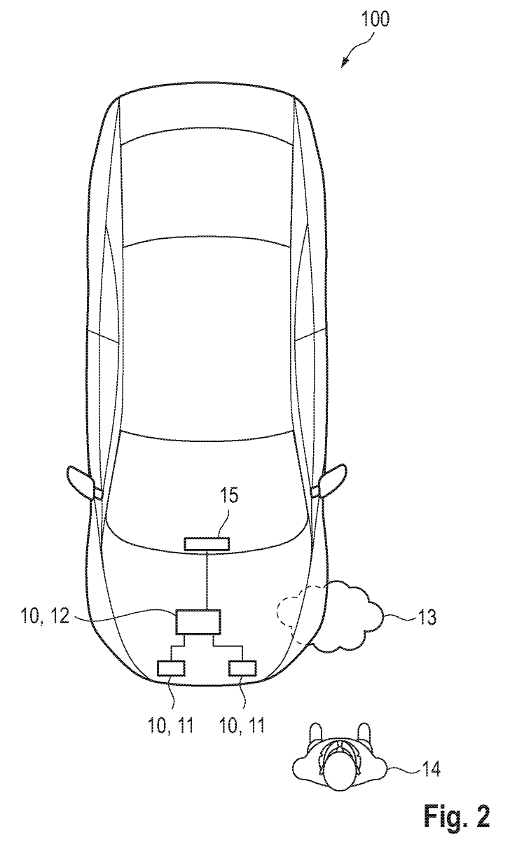

Referring now to the figures of the drawing in detail and thereby alternating between FIG. 1, which shows a flow chart of the novel method, and FIG. 2, which shows obstacles 13, 14 that have so far been unknown, to be recognized along a taught trajectory and handled separately over the course of further guidance of a vehicle 100 depicted in FIG. 2. The method comprises the step of guiding A the vehicle 100 along the trajectory taught by the driving assistance system 10. The driving assistance system may also be referred to as a driver assistance system or a driver assist system.

As shown in FIG. 2, the driving assistance system 10 comprises at least sensorics 11 for sensing obstacles 13, 14 in the environment of the vehicle and a control device 12.

A further step of the method according to FIG. 1 is sensing B at least one unknown obstacle 13, 14 along the trajectory, wherein the obstacle 13, 14 has not been recognized at the time of teaching the trajectory.

As shown in FIG. 2, the obstacle may be an obstacle 13 which is able to be driven over in the form of a shrub slightly protruding into the trajectory so that the vehicle 100 could in principle drive past the obstacle 13. Further, the obstacle may be an obstacle 14 which is unable to be driven over, for example in the form of a person 14.

The driving assistance system may now output (C1) a query to a driver of the vehicle (100) related to performing an action for handling the unknown obstacle (13, 14) by the driving assistance system 10. The action may be, for example, aborting the guidance of the vehicle 100 along the trajectory, driving around the obstacle 13, 14, or disregarding, either once or permanently, the obstacle 13, 14.

In the case shown in FIG. 2, the driver may, for example, establish that the obstacle 13, being a flexible shrub, can temporarily be disregarded. With regard to the obstacle 14, being a person, the driver may establish that the automated trip is to be aborted.

Alternatively, the driver may edit (C2) the trajectory in a communication device to establish how to handle the obstacle (13, 14) during further driving.

Both the result of the query and the result of editing the trajectory by the driver may subsequently be stored in the driving assistance system (D).

### The following is a summary list of reference numerals and the corresponding structure used in the above description of the invention:

100 Vehicle

10 Driving assistance system

11 Sensorics

12 Control device

13 Obstacle able to be driven over

14 Unable to be driven over

15 Communication device

A, B, C1, C2, D Method steps

1. A method of operating a driving assistance system of a vehicle, the method comprising the following steps:
guiding the vehicle along a trajectory taught by the driving assistance system;
sensing at least one unknown obstacle along the trajectory, wherein the obstacle was not recognized at a time of teaching the trajectory; and
performing at least one of:
outputting a query to a driver of the vehicle related to performing an action for handling the unknown obstacle by the driving assistance system; or
editing the trajectory in a communication device by the driver.

2. The method according to claim 1, wherein the obstacle is vegetation, a living being, a ground region, a curb, a building, or an infrastructure device.

3. The method according to claim 1, wherein the sensing step comprises sensing the unknown obstacle by the driver or by sensorics of the driving assistance system.

4. The method according to claim 1, wherein the action for handling the unknown obstacle comprises aborting guiding the vehicle along the trajectory.

5. The method according to claim 1, wherein the action for handling the unknown obstacle comprises driving around the obstacle.

6. The method according to claim 5, which comprises having the driver monitor the driving around the obstacle, or having the driver guide the vehicle while driving around the obstacle.

7. The method according to claim 1, wherein the action for handling the unknown obstacle comprises disregarding the obstacle.

8. The method according to claim 1, which comprises disregarding the obstacle once or permanently.

9. The method according to claim 1, wherein the action for handling the unknown obstacle comprises increasing or decreasing a safe distance from the obstacle.

10. The method according to claim 1, wherein the action for handling the unknown obstacle comprises increasing or decreasing a speed of the vehicle while driving along the obstacle.

11. The method according to claim 1, which comprises storing the obstacle in data of the trajectory.

12. The method according to claim 1, which comprises classifying the obstacle by the driver or by the driving assistance system as an obstacle that is able to be driven over or is unable to be driven over.

13. The method according to claim 1, wherein the step of editing the trajectory by the driver comprises adjusting at least one region along the trajectory.

14. The method according to claim 1, wherein the step of editing the trajectory comprises classifying the obstacle.

15. A driving assistance system configured for performing the method according to claim 1.

16. A vehicle, comprising a driving assistance system configured for performing the method according to claim 1.
